(19) United States
(12) Patent Application Publication
(10) Pub. No.: US 2008/0248452 A1
(43) Pub. Date: Oct. 9, 2008

(54) Method and apparatus for demonstrating hydrocephalus treatment

(75) Inventors: Dorothy A. Kranz, San Francisco, CA (US); Sarah S. Zadoroznyj, Saddle Brook, NJ (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: Hydrocephalus Association

(21) Appl. No.: 11/732,885

(22) Filed: Apr. 5, 2007

(51) Int. Cl. G09B 23/34

(52) U.S. Cl. 434/268

(57) ABSTRACT

Method and apparatus for demonstrating hydrocephalus shunt implantation includes a fabricated body including a fill, a shell covering the fill and including respective torso, head, and valve openings formed in the shell, a simulated torso including the torso opening, and a simulated head including the head and valve openings. An implant includes an abdominal tube attached to the body within the torso opening and a ventricular tube attached to the body within the head opening. An insertion tube is selectively insertable and useable to thread each of the abdominal and ventricular tubes beneath the shell from the respective torso and head openings to the valve opening, for example, along a pocket of the body formed therebetween. The implant can further include a simulated valve connectible to respective free ends of the abdominal and ventricular tubes. The simulated valve can be passable into the body via the valve opening, and a flap can close the valve opening over the simulated valve.

### BACKGROUND OF THE INVENTION

1. Field of the Invention

Embodiments of the present invention generally relate to a method and apparatus for demonstrating medical treatments and, in particular, the invention relates to demonstrating hydrocephalus shunt implantation to, for example, children and their caregivers.

2. Description of the Related Art

The word Hydrocephalus comes from the Greek: “hydro”, meaning water, and “cephalus”, meaning head. Hydrocephalus is an abnormal accumulation of cerebrospinal fluid (CSF) within cavities called ventricles inside the brain. CSF is produced in the ventricles, circulates through the ventricular system, and is absorbed into the blood stream. CSF is in constant circulation and has many important functions. It surrounds the brain and spinal cord and acts as a protective cushion against injury. CSF contains nutrients and proteins necessary for the nourishment and normal function of the brain. It also carries waste products away from surrounding tissues. Hydrocephalus occurs when there is an imbalance between the amount of CSF that is produced and the rate at which it is absorbed. As the CSF builds up, it causes the ventricles to enlarge and the pressure inside the head to increase.

Presently, there is no known way to prevent or cure hydrocephalus. The most effective treatment is the surgical implantation of a shunt. A shunt is a flexible tube placed into the ventricular system that diverts the flow of CSF into another region of the body where it can be absorbed, such as the abdominal cavity. A shunt comprises a ventricular tube, a valve, and an abdominal (peritoneal) tube. The shunt tubes are about ⅛ inch in diameter and are made of a soft and pliable plastic that is well tolerated by our body tissues. The valve in the shunt is designed to maintain the CSF at normal pressure within the ventricles.

To surgically place a shunt, the surgeon makes incisions in the head and abdominal areas. The tubes are passed into the fatty tissue that lies just beneath the skin. A small hole is made in the skull, and the membranes between the skull and brain are opened, generally by boring a hole therethrough. One end of the shunt, called the ventricular tube, is gently passed through the brain into the lateral ventricle. The other end, called the abdominal tube, is passed beneath the skin into the abdominal cavity through a small opening in the lining (peritoneum) of the abdomen. This is where the CSF will ultimately be absorbed. The valve is located on the back or the top of the head beneath the skin. The incisions are then closed.

The foregoing surgical shunt implantation technique is commonly performed on children. Often, such children are so young that it may be difficult for them to understand why the procedure is being performed, or how the shunt system that has been surgically placed within their body functions to relieve their hydrocephalus. Such children may also have friends and family members who are similarly too young to readily understand the details of this medically necessary treatment.

Therefore, there is a need in the art for a method and apparatus for educating children with respect to the details of shunt-based surgical treatments for hydrocephalus.

### SUMMARY OF THE DISCLOSURE

The invention includes a method and apparatus for demonstrating hydrocephalus shunt implantation. For example, the invention includes an apparatus comprising a fabricated body including a fill, a shell covering the fill and including respective torso, head, and valve openings formed in the shell, a simulated torso defined by the fill and the shell and including the torso opening, and a head defined by the fill and the shell and including the respective head and valve openings. The apparatus also comprises an implant including an abdominal tube attached to the body within the torso opening and a ventricular tube attached to the body within the ventricular opening. The apparatus further comprises an insertion tube having a diameter larger than those of the respective abdominal and ventricular tubes, and being useable to thread each of the abdominal and ventricular tubes beneath the shell from the respective torso and head openings to the valve opening.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of an apparatus for educating children and others with respect to hydrocephalus shunt implantation in accordance with one embodiment;

FIG. 2 is a rear view of an object of the apparatus;

FIGS. 3 and 4 are illustrations of the apparatus of FIGS. 1-2 being used to demonstrate implanting a shunt in the object.

### DETAILED DESCRIPTION

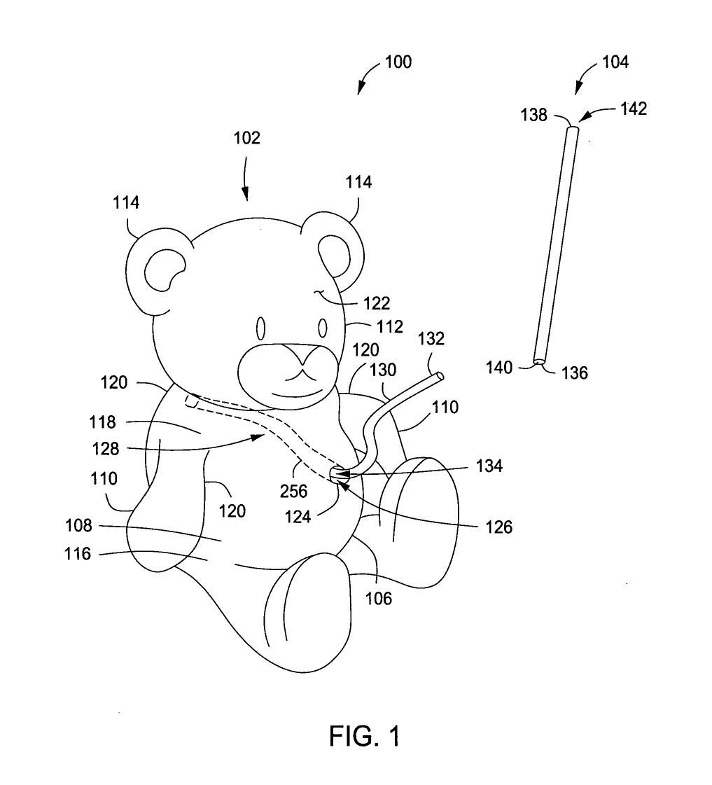

FIG. 1 illustrates apparatus 100 that children with hydrocephalus, their young friends and family members, and/or their caregivers may use to develop an understanding of the structure and function of a surgically-implanted shunt. The apparatus 100 includes an object 102 in the form of a specially configured plush toy, such as a toy bear, and an insertion tube 104. The object 102, shown in front elevational view, includes a body 106 having the typical body parts of a conventional toy bear, including a torso 108, two arms 110, a head 112, and two ears 114. The torso 108 includes an abdomen 116, a chest 118, and shoulders 120. The body 106 further includes a shell 122, the shell 122 being made, for example, from a plush fabric that has a soft exterior surface (e.g., for the comfort of children and others touching and handling the body 106), and being shaped and otherwise cut, sewn and/or stuffed (e.g., stuffed with a fill (not separately shown) of a resilient material, such as cotton batting) so as to give the body 106 a ‘teddy bear’ shape. The shell 122 includes an edge 124 that defines a torso opening 126 formed in the fabric of the shell 122 in the vicinity of the abdomen 116. The edge 124 is reinforced with heavy stitching so as to resist tearing or undue widening. The structure and function of the body 106 is described in greater detail hereinbelow.

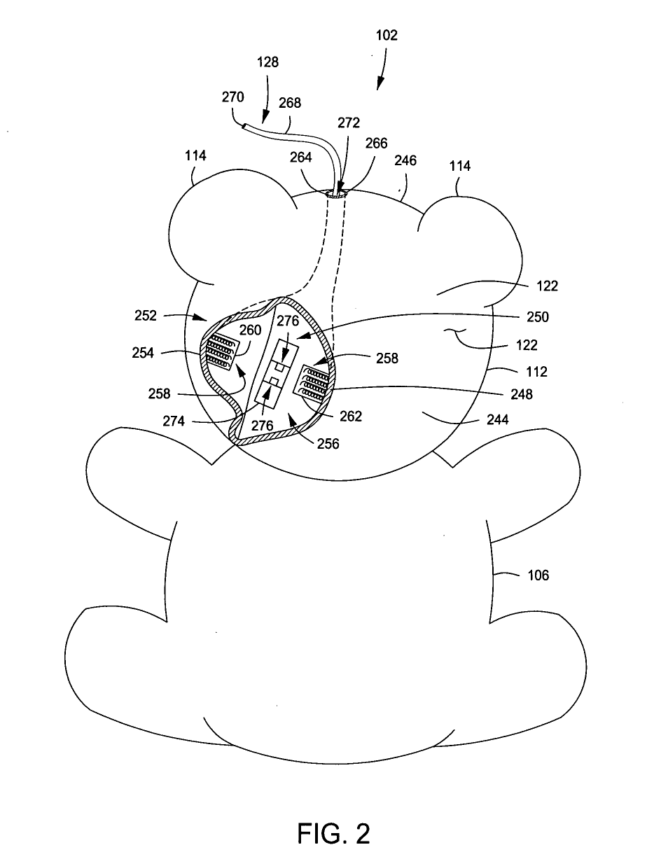

The object 102 further includes an implant 128. The implant 128 includes, in part, an abdominal tube 130, which can be, for example, a fine-gage latex tube similar to the tubes used in real shunts. The abdominal tube 130 is elongate, and includes a free end 132 and a distal end 134 (obscured). In FIG. 1, the abdominal tube 130 is shown extending outward of the torso opening 126 from within the shell 122. The distal end 134 is attached to the body 106 beneath the shell 122 (e.g., attached to the fill (not shown) that the shell 122 covers, or to a pocket beneath the shell 122 (e.g., to the fabric or membrane material of a pocket 256 of the body 106 shown and described hereinbelow with reference to FIG. 2)) and within the opening 126 by stitches, glue, VELCRO, staples, and the like. The structure and function of the implant 128 is described in greater detail hereinafter.

The insertion tube 104 is rigid or semi-rigid, e.g., akin to a drinking straw or the like, and includes opposing ends 136, 138. The end 136 includes a mouth 140, and the end 138 includes a mouth 142. The insertion tube 104 has a diameter that is larger than a diameter of the abdominal tube 130. The structure and function of the insertion tube 104 is described in further detail hereinafter.

FIG. 2 illustrates a rear view of the object 102. The head 112 of the body 106 includes a back 244 and a top 246. At the back 244 of the head 112, the shell 122 includes an edge 248 that defines a valve opening 250 formed in the fabric of the shell 122. The edge 248 is reinforced with heavy stitching so as to resist tearing or undue widening. The valve opening 250 is somewhat larger than the torso opening 126 shown in FIG. 1, and further features a flap 252 formed from a portion of the fabric of the shell 122, and that is adapted to be pulled up and away from the back 244 of the head 112, as shown, thereby revealing an interior surface 254 of the shell 122 that otherwise faces generally inward of the body 106.

The body 106 further includes lightweight fabric or membrane material in sufficient quantity, and so arranged as to form a pocket 256. The pocket 256 extends from the abdomen 116 in the vicinity of the torso opening 126 (see FIG. 1), upward underneath the shell 122 across the chest 116 and a shoulder 120 of the torso 108 above one of the arms 110 of the body 106, (see also FIG. 1) and extends onward and upward therefrom, still beneath the shell 122, along the back 244 of the head 112. The pocket 256 is further provided with an opening (not separately indicated) of a size, shape, and location so as to communicate with the valve opening 250 formed in the shell 122. The membrane or fabric of the pocket 256 is attached together with the interior surface 254 of the shell 122 by means of the stitching provided along the edge 248. In this way, a position of the pocket 256 beneath and adjacent to the shell 122, and relative to the remainder of the body 106, is stabilized. A similar interconnection between the pocket 256 and the shell 122 is provided at the torso opening 126 (see FIG. 1), thereby providing further stability.

A fastener 258 is incorporated within the back 244 of the head 112 in the vicinity of the flap 252. The fastener 258 is of the hook-and-pile variety (e.g., VELCRO), and includes a fastener portion 260 attached to the flap 252 adjacent the edge 248. The fastener 258 also includes a fastener portion 262 attached to the shell 122 within the pocket 256 and adjacent the edge 248. As shown in the embodiment of FIG. 2, the fastener portion 260 is the ‘pile’ portion of the fastener 258 and the fastener portion 262 is the ‘hook’ portion thereof. In other embodiments, the reverse may be the case.

The pocket 256 extends upward from the back 244 of the head 112, still beneath the shell 122, to the top 246 of the head 112. At the top 246 of the head 112, between the ears 114, the shell 122 further includes an edge 264 that defines a head opening 266 formed in the fabric of the shell 122. The edge 264 is reinforced with heavy stitching so as to resist tearing or undue widening. The head opening 266 is of similar size to the torso opening 126 shown in FIG. 1. An interconnection similar to that described hereinabove between the pocket 256 and the shell 122 at the torso and valve openings 126, 250, is also provided at the head opening 266.

The implant 128 further includes a ventricular tube 268, which can be, for example, a fine-gage latex tube similar to the tubes used in real shunts. The ventricular tube 268 is elongate, includes a free end 270 and a distal end 272 (obscured) and has a diameter smaller than that of the insertion tube 104. In FIG. 2, the ventricular tube 268 is shown extending outward of the head opening 266 from within the shell 122. The distal end 272 is attached to the body 106 beneath the shell 122 (e.g., attached to the fill (not shown) that the shell covers, and/or to the fabric or membrane material of the pocket 256) and within the head opening 266 by stitches, glue, VELCRO, staples, and the like.

The implant 128 still further includes a simulated valve 274 that can be removably positioned within the pocket 256. In an alternative embodiment, the valve 274 is attached to the body 106 within the pocket 256. The valve 274 comprise two couplers 276, one each for the respective free ends 132 (FIG. 1), 270 of the abdominal and ventricular tubes 130 (FIG. 1), 268.

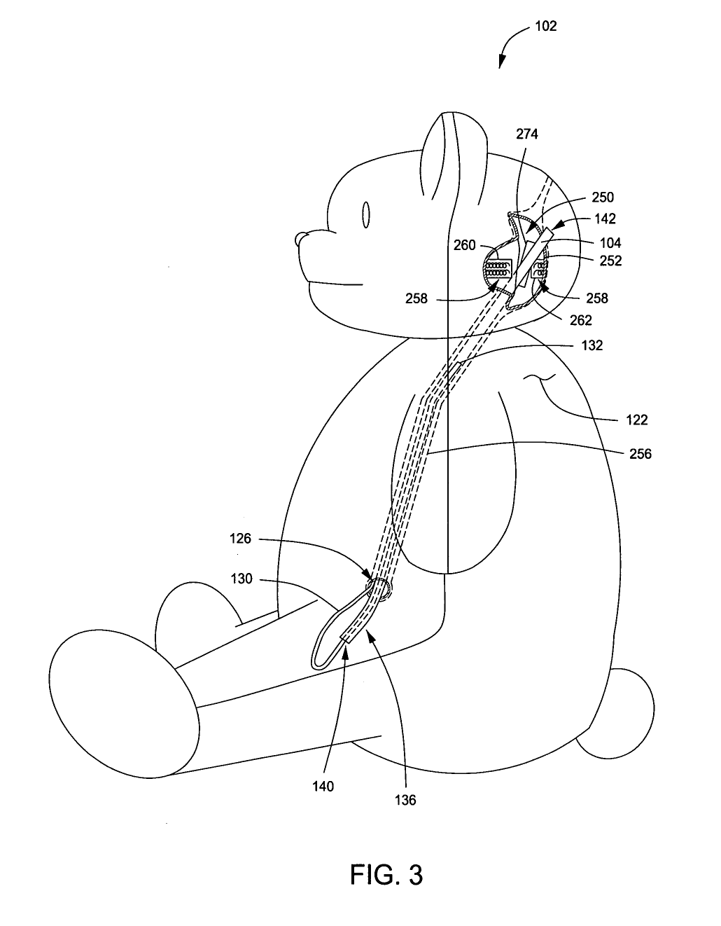

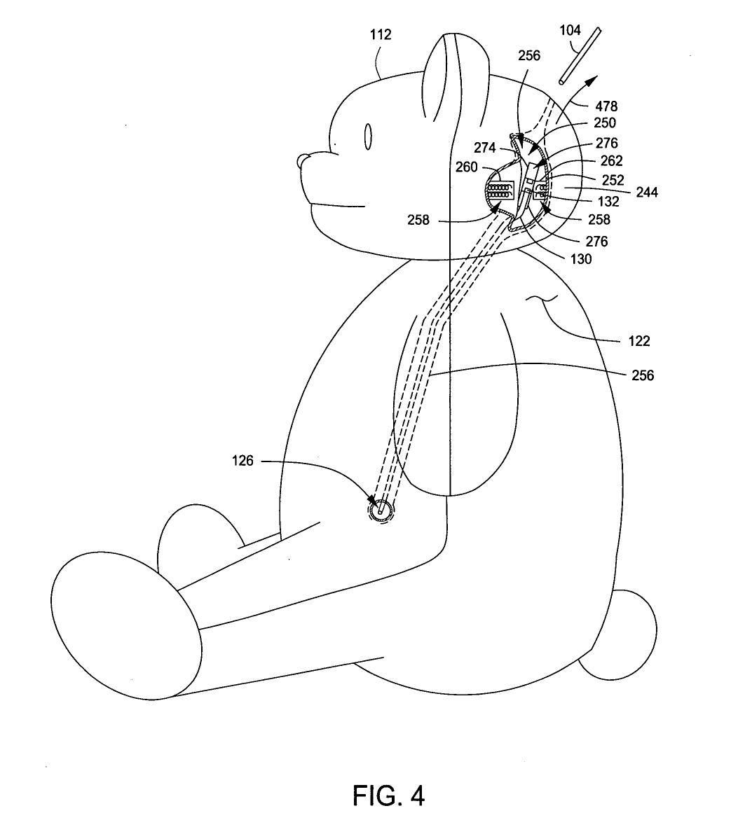

Referring now to FIGS. 3-4, the insertion tube 104 can be used in cooperation with the object 102 to guide the abdominal tube 130 upward through the pocket 256 toward the simulated valve 274. Referring now specifically to FIG. 3, a user pulls on the flap 252 to disengage the fastener portions 260, 262 of the fastener 258 apart from each other (see, e.g., FIG. 1), and rotates the flap 252 away from the remainder of the shell 122 so as to open the valve opening 250 and expose the simulated valve 274. The end 136 of the insertion tube 104 is inserted into the valve opening 250 and is threaded downward through the pocket 256 toward the torso opening 126. In order to facilitate the foregoing step, one or both of the shell 122 and the fill (not separately shown) covered by the shell 122 is relatively pliable relative to the insertion tube 104. With the end 136 of the tube 104 extending generally outward of the torso opening 126, the free end 132 of the abdominal tube 130 is passed into the mouth 140 of the insertion tube 104 and is threaded upward therethrough in the direction of the mouth 142 of the insertion tube 104 until such time as a substantial portion of the length of the abdominal tube 130 is contained within the insertion tube 104.

As shown in FIG. 4, the insertion tube 104 is then pulled back outward of the pocket 256 along the direction indicated by arrow 478 until such time as the free end 132 of the abdominal tube 130 appears in the vicinity of the valve opening 250. (The insertion tube 104 is now put aside.) The free end 132 of the abdominal tube 130 is then inserted into one of the couplers 276 of the simulated valve 274. In order to facilitate the foregoing step, the abdominal tube 130 can be relatively flexible so as to permit the abdominal tube 130 to be bent and maneuvered easily within the insertion tube 104 upon the free end 132 of the abdominal tube 130 being threaded therethrough.

The process of threading the abdominal tube 130 upward through the pocket 256 from the vicinity of the torso opening 126 to the vicinity of the valve opening 250 is repeated, e.g., with respect to all related or corresponding aspects, in order to thread the ventricular tube 268 (FIG. 2) downward through the pocket 256 from the vicinity of the head opening 266 (FIG. 2) to the vicinity of the valve opening 250. In particular, once the insertion tube 104 is pulled outward of the pocket 256 such that the free end 270 of the ventricular tube 268 appears in the vicinity of the valve opening 250, the insertion tube 104 is once again put aside. The free end 270 of the ventricular tube 268 is then inserted into the other coupler 276 of the simulated valve 274. In order to facilitate the foregoing step, the ventricular tube 268 can be relatively flexible so as to permit the ventricular tube 268 to be bent and maneuvered easily within the insertion tube 104 upon the free end 270 of the ventricular tube 268 being threaded therethrough.

With each of the abdominal and ventricular tubes 130, 268 (FIG. 2) extending from the respective torso and head openings 126, 266 (FIG. 2) toward the valve opening 250 formed in the shell 122 and connected to the simulated valve 274, all of the components representative of a shunt for treating hydrocephalus will have been placed in subcutaneous positions in the body 106 of the plush toy bear corresponding to those at which such a shunt would be surgically implanted and arranged in a human child with hydrocephalus. The flap 252 is then rotated back toward the remainder of the shell 122 at the back 244 of the head 112, causing the fastener portions 260, 262 of the fastener 258 to adhere to each other, thereby securing the flap 252 in place over the pocket 256, closing the valve opening 250, and obscuring the simulated valve 274 from view.

The foregoing description of the operation of the apparatus 100 also serves as a description of how the apparatus 100 may be used to demonstrate hydrocephalus shunt implantation to a child with hydrocephalus, as well as their family members and young friends and classmates. That is, by operating the apparatus 100 as described above in the presence of such a person or persons, the desired demonstration will be accomplished with little need for verbal description. Once the shunt, its components, and position within the body is demonstrated, either the demonstrator, or the person or persons to whom the shunt implantation was demonstrated, may reopen the flap 252, disconnect the tubes 130, 268 (FIG. 2) from the simulated valve 274, pull the tubes 130, 268 back out of the respective portions of the pocket 256 that lead to the valve opening 250, and pull the tubes 130, 268 out of the respective torso and head openings 126, 266 (FIG. 2), so as to prepare the apparatus 100 for a repetition of the demonstration process, as needed or as desired.

In alternative embodiments of the apparatus 100, each of the respective distal ends 134, 272 of the abdominal and ventricular tubes 130, 268 is affixed or anchored to a respective coupler 276 of the valve 274, rather than to the fill (not separately shown) or the pocket 256 of the body 106. In accordance with such alternative embodiments, the insertion tube 104 is used to guide the respective free ends 132, 270 of the abdominal and ventricular tubes 130, 268 respectively downward and upward through the pocket 256 toward the respective torso and head openings 126, 266, rather than respectively upward and downward therethrough toward the simulated valve 274.

While the foregoing is directed to embodiments of the present invention, other and further embodiments of the invention may be devised without departing from the basic scope thereof, and the scope thereof is determined by the claims that follow.

1. Apparatus for demonstrating hydrocephalus shunt implantation, comprising:
a fabricated body including a fill, a shell covering the fill and including respective torso, head, and valve openings formed in the shell, a simulated torso defined by the fill and the shell and including the torso opening, and a head defined by the fill and the shell and including the respective head and valve openings;
an implant including an abdominal tube attached to the body within the torso opening and a ventricular tube attached to the body within the head opening; and
an insertion tube having a diameter larger than those of the respective abdominal and ventricular tubes and being selectively insertable and useable to thread each of the abdominal and ventricular tubes beneath the shell from the respective torso and head openings to the valve opening.

2. The apparatus of claim 1, wherein the implant further includes a simulated valve adapted to be connected to respective free ends of the abdominal and ventricular tubes in the vicinity of the valve opening.

3. The apparatus of claim 2, wherein the simulated valve is adapted to be passed into the body via the valve opening, and the shell further includes a flap proximate the valve opening for extending over and obscuring the simulated valve from view.

4. The apparatus of claim 3, wherein the body further includes a fastener for securing the flap over the simulated valve and for at least partially closing the valve opening.

5. The apparatus of claim 2, wherein the implant forms a facsimile of a shunt used in patients with hydrocephalus.

6. The apparatus of claim 1, wherein the insertion tube is selectably insertable and useable to thread each of the abdominal and ventricular tubes between the fill and the shell from the respective torso and head openings to the valve opening.

7. The apparatus of claim 1, wherein the body further includes a pocket formed between the shell and the fill and extending from the torso and head openings, respectively, to the valve opening, the pocket having a diameter larger than the diameter of the insertion tube and defining a space through which the insertion tube is inserted.

8. The apparatus of claim 1, wherein at least one of the shell and the fill is relatively pliable relative to the insertion tube.

9. The apparatus of claim 1, wherein the insertion tube is elongate and substantially straight in shape and is relatively rigid relative to at least one of the shell and the fill.

10. The apparatus of claim 1, wherein the fill includes a resilient stuffing material, and the shell includes a plush fabric.

11. The apparatus of claim 1, wherein the body has a non-human animal shape.

12. A method of demonstrating hydrocephalus shunt implantation, comprising:
positioning an insertion tube beneath an outer shell of a fabricated demonstration body and between a torso opening formed in the outer shell in a torso of the body and a valve opening formed in the outer shell in a head of the body;
threading an abdominal tube through the insertion tube; and
removing the insertion tube so as to leave the abdominal tube threaded between the respective torso and valve openings.

13. The method of claim 12, further comprising:
positioning an insertion tube beneath the outer shell and between a head opening formed in the outer shell in the head of the body and the valve opening;
threading a ventricular tube through the insertion tube; and
removing the insertion tube so as to leave the ventricular tube threaded between the respective head and valve openings.

14. The method of claim 12, further comprising:
connecting a free end of the abdominal tube to a simulated valve.

15. The method of claim 14, further comprising:
implanting the simulated valve into the body within the valve opening.

16. The method of claim 15, further comprising:
closing the valve opening so as to at least partially hide the simulated valve from direct view.

17. The method of claim 16, wherein the closing step includes extending a flap over the simulated valve and fastening the flap in place thereat.

18. The method of claim 12, further comprising:
removing the abdominal tube from between the respective torso and valve openings; and
threading the abdominal tube outward of the body through the torso opening.

19. Apparatus for demonstrating hydrocephalus shunt implantation, comprising:
a fabricated body having an animal shape and including a fill, a shell covering the fill and including respective torso, head, and valve openings formed in the shell, a simulated torso defined by the fill and the shell and including the torso opening, a head defined by the fill and the shell and including the respective head and valve openings;
an implant including an abdominal tube attached to the body within the torso opening, a ventricular tube attached to the body within the head opening, and a simulated valve adapted to be passed into the body via the valve opening, and to be connected to respective free ends of the abdominal and ventricular tubes in the vicinity of the valve opening, wherein the shell further includes a flap proximate the valve opening for extending over and obscuring the simulated valve from view, and wherein the body further includes a fastener for securing the flap over the simulated valve and for at least partially closing the valve opening; and
an insertion tube having a diameter larger than those of the respective abdominal and ventricular tubes and being selectively insertable and useable to thread each of the abdominal and ventricular tubes beneath the shell from the respective torso and head openings to the valve opening.
